(19) United States
(12) Patent Application Publication
(10) Pub. No.: US 2026/0118742 A1
(43) Pub. Date: Apr. 30, 2026

(54) BUFFER ASSEMBLY AND VEHICLE-MOUNTED FILMING DEVICE

(71) Applicant: TILTA INC., Burbank, CA (US)

(72) Inventors: Jiawen KANG, Shenzhen (CN); Wenping ZENG, Shenzhen (CN); Kefeng ZHOU, Shenzhen (CN)

(21) Appl. No.: 19/369,039

(22) Filed: Oct. 24, 2025

(30) Foreign Application Priority Data
Oct. 30, 2024 (CN) 202422648896.6

(51) Int. Cl. G03B 17/56; F16F 15/08

(52) U.S. Cl. CPC G03B 17/561; F16F 15/08

(57) ABSTRACT

A buffer assembly includes a first base, a second base, and a plurality of buffer assemblies. The first base is designed for connection to an external structure, while the second base provides a mounting position for a filming device. The buffer assemblies encircle the second base, with one end of each buffer assembly positioned on the first base and the other on the second base, to buffer the filming device. The vehicle-mounted filming device can be affixed to a vehicle via a suction cup, its angle adjusted via a connecting arm, pitch vibration mitigated via a shock absorption bracket, and swinging of the filming device buffered via the buffer assembly, ensuring filming stability.

### CROSS-REFERENCE TO RELATED APPLICATIONS

The present application for patent claims priority to and the benefit of pending Chinese Application No. 202422648896.6, filed October 30, 2024, and hereby expressly incorporated by reference herein as if fully set forth below in its entirety and for all applicable purposes.

### TECHNICAL FIELD

The present disclosure pertains to the technical field of photographic accessory equipment, specifically to a buffer assembly and a vehicle-mounted filming device.

### INTRODUCTION

Currently, in mobile filming scenarios, both indoors and outdoors, filming devices are often mounted on brackets attached to vehicles to meet the demands of mobile vehicle filming. However, during vehicle movement, factors such as road bumps or the need to turn can cause the filming device to experience swinging forces, compromising the stability of the captured footage.

### BRIEF SUMMARY

The present disclosure provides a buffer assembly and a vehicle-mounted filming device capable of absorbing swinging forces acting on the filming device in corresponding directions, thereby effectively minimizing the swing of the filming device and ensuring smooth, stable footage.

According to some aspects of the disclosure, a buffer assembly includes:

a first base, designed for connection to an external structure;

a second base, featuring a mounting position for a filming device; and

a plurality of buffer assemblies, encircling the second base, with one end of each assembly positioned on the first base and the other on the second base, to buffer the filming device.

This disclosure also introduces a vehicle-mounted filming device including a suction cup, a shock absorption bracket, a connecting arm, and the aforementioned buffer assembly. One end of the connecting arm is connected to the suction cup, the other end to the shock absorption bracket, and the opposite end of the shock absorption bracket is connected to the first base.

The vehicle-mounted filming device can be affixed to a vehicle via the suction cup, its angle adjusted via the connecting arm, pitch vibration mitigated via the shock absorption bracket, and swinging of the filming device buffered via the buffer assembly, ensuring filming stability.

### BRIEF DESCRIPTION OF THE DRAWINGS

To elucidate the technical solutions presented in the embodiments of the present disclosure, the accompanying drawings for describing these embodiments will be briefly introduced below. It is apparent that the accompanying drawings described herein represent merely some embodiments of the present disclosure. For those skilled in the art, other drawings illustrating variations of the depicted devices can be readily derived by those skilled in the art without requiring inventive effort.

FIG. 1 is a schematic diagram of a shock absorption device according to some aspects of the present disclosure.

FIG. 2 is an exploded view of the shock absorption device according to some aspects of the present disclosure.

FIG. 3 is an exploded view of a buffer assembly according to some aspects of the present disclosure.

FIG. 4 is another exploded view of the buffer assembly according to some aspects of the present disclosure.

FIG. 5 is another exploded view of the buffer assembly according to some aspects of the present disclosure.

FIG. 6 is a schematic diagram of the buffer assembly according to some aspects of the present disclosure.

FIG. 7 is a cross-sectional view of the buffer assembly according to some aspects of the present disclosure.

### Reference Numerals:

100. Vehicle-mounted filming device; 10. Buffer assembly; 20. Suction cup; 30. Shock absorption bracket; 301. First link; 302. Second link; 303. Third link; 3031.

Clamping groove; 304. Fourth link; 305. Shock absorption assembly; 306. Locking mechanism; 3061. Locking lever; 3062. Pressing block; 40. Connecting arm; 401. Branch arm;

1. First base; 11. Quick release plate; 110. First limiting port;

2. Second base; 21. Second limiting port; 22. Mounting platform; 221. Mounting position; 222. Mounting interface; 23. Mounting groove; 24. Mounting arm;

3. Buffer assembly; 31. Damper body; 32. Moving rod; 33. Bearing; 34. Elastic damping ball; 341. First limiting part; 342. Damping ball body; 343. Second limiting part;

4. Locking assembly; 41. Operation part; 411. Connecting shaft; 412. Knob; 413. Anti-loosening screw; 414. Circlip; 42. Abutment part; 421. Soft pad layer.

The objectives, functional features, and aspects of this disclosure will be further elaborated with reference to the accompanying drawings and in conjunction with exemplary embodiments.

### DETAILED DESCRIPTION

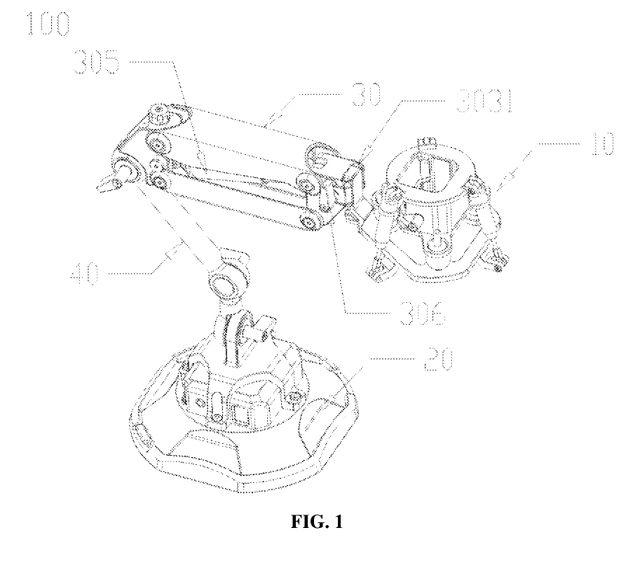

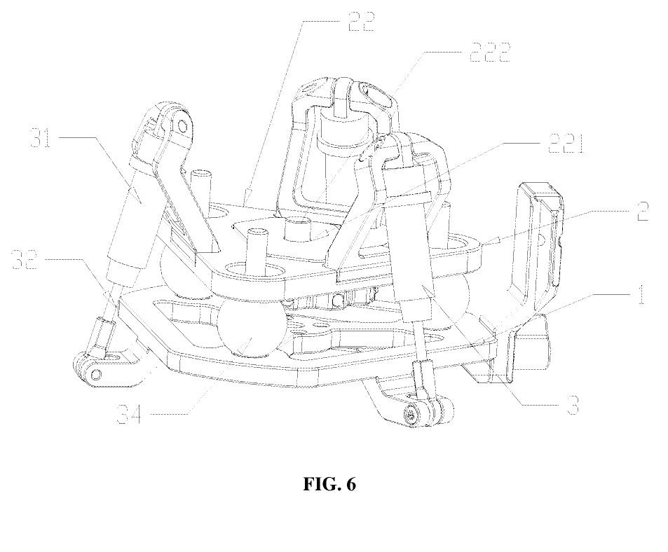

Referring to FIGS. 1-7, the present disclosure provides a vehicle-mounted filming device 100 including a suction cup 20, a shock absorption bracket 30, a connecting arm 40, and a buffer assembly 10. One end of the connecting arm 40 is connected to the suction cup 20, the other end connected to the shock absorption bracket 30, and the opposite end of the shock absorption bracket 30 is connected to the first base 1.

The vehicle-mounted filming device 100 can be affixed to a vehicle via the suction cup 20, its angle adjusted via the connecting arm 40, pitch vibration mitigated via the shock absorption bracket 30, and swinging of the filming device buffered via the buffer assembly 10, ensuring filming stability.

For example, the suction cup 20 can be a commercially available electric suction cup 20. The connecting arm 40 includes a plurality of branch arms 401 sequentially connected via cranksets. The first and last branch arms 401 can also be connected and locked to the electric suction cup 20 and the shock absorption bracket 30, respectively, for example, via cranksets.

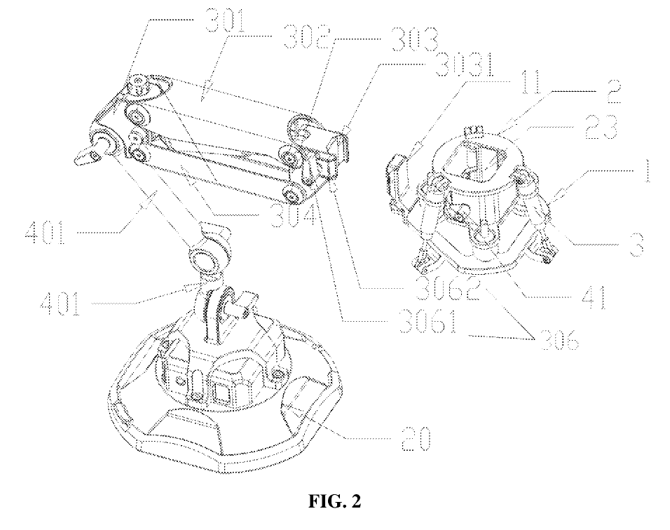

Referring to FIGS. 1-2, the shock absorption bracket 30 includes a four-bar linkage component and a shock absorption assembly 305. It includes a first link 301, a second link 302, a third link 303, and a fourth link 304, hinged together pairwise via pivot pins or the link. One end of the shock absorption assembly 305 is hinged to the first link 301, and the other end to the connection point of the second link 302 and the third link 303. The shock absorption assembly 305 can be a commercially available damping shock absorber, metal spring shock absorber, air shock absorber, etc.

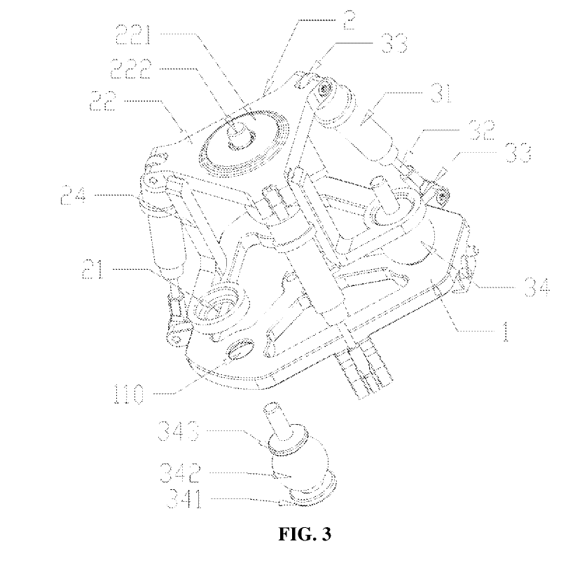

Referring to FIGS. 3-6, the buffer assembly 10 is connected to the third link 303. For example, the third link 303 features a clamping groove 3031 (e.g., a slot) and a locking mechanism 306. The first base 1 is equipped with a quick release plate 11 that can be slidably positioned within the clamping groove 3031. The locking mechanism 306 includes a locking lever 3061 and a pressing block 3062. The locking lever 3061 is threadedly connected to the third link 303 and can rotate relative to it to drive the pressing block 3062 against the quick release plate 11, thereby locking the quick release plate 11 within the clamping groove 3031 and connecting the shock absorption bracket 30 and the buffer assembly 3 together. In some aspects, rotating the locking lever in the opposite direction unlocks the pressing block 3062 and the quick release plate 11.

Referring to FIGS. 3-6, the buffer assembly 10 includes a first base 1, a second base 2, and a plurality of buffer assemblies 3. The first base 1 is designed for connection to an external structure, while the second base 2 provides a mounting position 221 for a filming device. The buffer assemblies 3 encircle the second base 2, with one end of each assembly positioned on the first base 1 and the other end on the second base 2, to buffer the filming device. This external structure can be the shock absorption bracket 30.

In this configuration, during motion filming, when the filming device tends to swing due to filming conditions, such as during turns or circular movements, the buffer assemblies 3 can absorb the swinging forces in the corresponding directions, reducing the swing of the filming device and improving filming stability.

For example, the buffer assembly 3 can be a damper. The damper includes a damper body 31 and a moving rod 32. One end of the damper body 31 and one end of the moving rod 32 are movably connected, and the other ends of the damper body 31 and the moving rod 32 are hinged to the first base 1 or the second base 2, respectively. During motion filming, depending on the conditions of the filming device, the corresponding moving rod 32 can extend or retract relative to its corresponding damper body 31 to absorb the swinging forces in the corresponding directions. The damper can be a hydraulic damper, a hydraulic feed speed control device, or the like.

In some aspects, referring to FIGS. 3-5, one end of the moving rod 32 is hinged to the first base 1 via a bearing 33, and the other end of the damper body 31 is hinged to the second base 2 via a bearing 33. This configuration allows the damper to pivot through a certain angle, meaning that when the first base 1 and the second base 2 move relative to each other, the damper can pivot accordingly to accommodate the relative movement.

In one example, three buffer assemblies 3 are symmetrically arranged around the periphery of the second base 2.

In some aspects, the buffer assemblies 3 further include a plurality of elastic damping balls 34. One end of each elastic damping ball 34 is connected to the first base 1, and the other end is connected to the second base 2. That is, the elastic damping balls 34 are positioned between the first base 1 and the second base 2, providing buffering for the movement between the first base 1 and the second base 2 during motion filming. In some aspects, the elastic damping balls 34 are made of an elastic material, such as silicone or rubber. On the other hand, the second base 2 has a plurality of mounting arms 24 corresponding one-to-one with the elastic damping balls 34.

Referring to FIGS. 3-6, the elastic damping ball 34 includes a connected first limiting part 341, a damping ball body 342, and a second limiting part 343. The first base 1 has a first limiting port 110 (e.g., an opening). The second base 2 has a second limiting port 21 (e.g., an opening). The size of the first limiting part 341 is larger than the first limiting port 110, and the first limiting part 341 is snap-fitted into the first limiting port 110. The size of the second limiting part 343 is larger than the second limiting port 21, and the second limiting part 343 is snap-fitted into the second limiting port 21. During installation, due to the elasticity of the elastic damping ball 34, the first limiting part 341 and the second limiting part 343 can be squeezed into the first limiting port 110 and the second limiting port 21, respectively, to complete the installation of the elastic damping ball 34.

Regarding the installation of the filming device, in one aspect, referring to FIGS. 3-6, the second base 2 includes a mounting platform 22, and the mounting position 221 is positioned on the mounting platform 22. The filming device can be installed on the mounting position 221 of the mounting platform 22, suitable for filming devices, for example, action cameras.

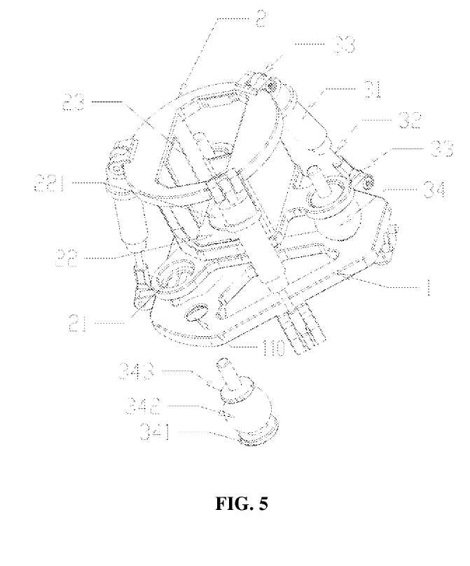

In some aspects, in some aspects, referring to FIG. 5, the second base 2 includes a mounting groove 23. The bottom of the mounting groove 23 is provided with a mounting platform 22 (below the mounting groove 23), and the mounting position 221 is positioned on the mounting platform 22. In this configuration, the filming device is accommodated within the mounting groove 23 and installed at the mounting position 221 on the mounting platform 22 at the bottom of the groove. The mounting groove 23 can limit the position of the filming device, making it suitable for filming devices such as pocket gimbal cameras or action cameras attached with a desktop mini tripod or selfie stick.

Referring to FIGS. 3-5, for example, the mounting position 221 is provided with a mounting interface 222 for connecting the filming device. For example, the mounting interface 222 includes at least one of: a 1/4-inch screw, a 3/8-inch screw, a cold shoe mount, a cold shoe slot, a standardized mounting interface (e.g., NATO rail, NATO slot, Manfrotto rail, Manfrotto slot, Arca-type rail, and Arca-type slot). This allows compatibility with cameras having different interfaces, or with various standard interfaces on camera accessories to which a camera is mounted.

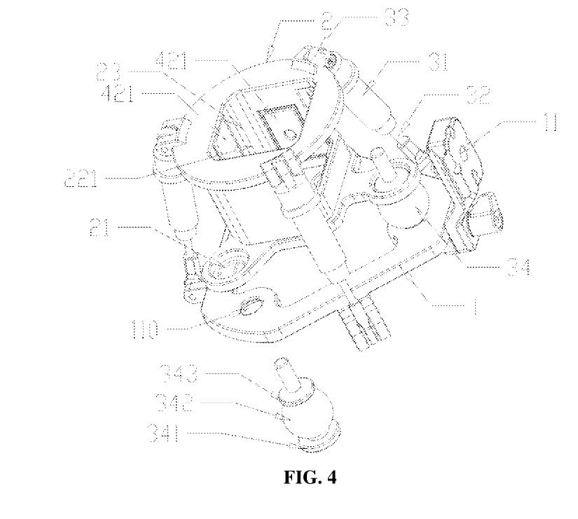

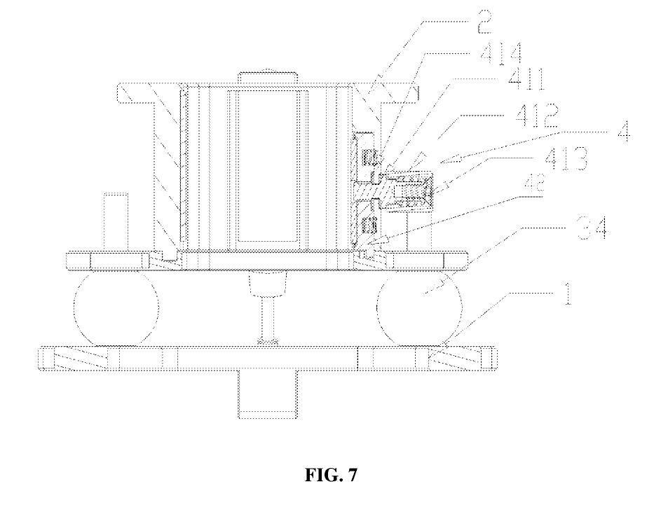

In some aspects, referring to FIG. 4 and FIG. 7, the second base 2 includes a mounting groove 23, and the mounting position 221 is positioned within the mounting groove 23; that is, the mounting position 221 is the mounting groove 23. Herein, the buffer assembly 10 further includes a locking assembly 4. The locking assembly 4 is movably positioned on the wall of the mounting groove 23 and is used for pressing against the filming device. This configuration is suitable for filming devices such as pocket gimbal cameras or action cameras attached with a desktop mini tripod or selfie stick. For example, the filming device is inserted into the mounting groove 23 and then locked in place by the locking assembly 4. The locking assembly 4 includes an operation part 41 and an abutment part 42. The operation part 41 and the abutment part 42 are threadedly connected. When the operation part 41 is rotated, the abutment part 42 moves relative to the operation part 41, causing the side of the abutment part 42 facing away from the operation part 41 to press against the filming device. It is noteworthy that a circlip 414 is sleeved on the connecting shaft 411 and positioned between the abutment part 42 and the wall of the mounting groove 23. It is used to prevent the operation part 41 from axially disengaging from the mounting groove 23 during locking. Therefore, when rotating the operation part 41, the abutment part 42 rotates relative to the operation part 41 and moves axially towards the filming device to press against it. The side of the abutment part 42 facing away from the operation part 41 has a soft pad layer 421 to protect the filming device and avoid scratching it. For example, the operation part 41 includes a connecting shaft 411, a knob 412, and an anti-loosening screw 413. A spring is positioned between the anti-loosening screw 413 and the connecting shaft 411. The knob 412 is sleeved outside the connecting shaft 411 and can engage with an internal hexagon of the connecting shaft 411 to drive the rotation of the connecting shaft 411. In some aspects, the knob 412 can be replaced with a lever. It is understandable that the inner walls of the aforementioned mounting groove 23 can also be provided with a soft pad layer 421 to protect the filming device. In some aspects, the aforementioned quick release plate 11 can also be connected to the first base 1 via a locking assembly 4, the principle of which can refer to the above description.

Although specific embodiments of the invention have been described in detail, it should be understood that the invention is not limited to the exact configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A buffer assembly, comprising:
a first base configured to connect to an external structure;
a second base provided with a mounting position for mounting a filming device; and
a plurality of buffer assemblies, wherein the plurality of buffer assemblies surround the second base; and
wherein a first end of each of the plurality of buffer assemblies is disposed on the first base and a second end of each of the plurality of buffer assemblies is disposed on the second base so as to buffer the filming device.

2. The buffer assembly according to claim 1, wherein each of the plurality of buffer assemblies comprises a damper body and a moving rod;
wherein a first end of the damper body is movably connected to a first end of the moving rod; and
wherein a second end of the damper body is hinged to one of the first base or the second base, and a second end of the moving rod is hinged to the other of the first base or the second base.

3. The buffer assembly according to claim 2, wherein the second end of the moving rod is hinged to the first base via a bearing, and the second end of the damper body is hinged to the second base via a bearing.

4. The buffer assembly according to claim 2, wherein the plurality of buffer assemblies comprise three buffer assemblies, which are symmetrically arranged around a periphery of the second base.

5. The buffer assembly according to claim 1, further comprising a plurality of elastic damping balls; and
wherein a first end of each of the elastic damping balls is connected to the first base and a second end of each of the elastic damping balls is connected to the second base.

6. The buffer assembly according to claim 5, wherein each of the plurality of elastic damping balls comprises a connected first limiting part, a damping ball body, and a second limiting part;
wherein the first base is provided with a first limiting port;
wherein the second base is provided with a second limiting port;
wherein a size of the first limiting part is greater than a size of the first limiting port;
wherein the first limiting part is engaged with the first limiting port;
wherein a size of the second limiting part is greater than a size of the second limiting port; and
wherein the second limiting part is engaged with the second limiting port.

7. The buffer assembly according to claim 1, wherein the second base comprises a mounting platform; and
wherein the mounting position is provided on the mounting platform.

8. The buffer assembly according to claim 1, wherein the second base is provided with a mounting groove;
wherein a bottom of the mounting groove is provided with a mounting platform; and
wherein the mounting position is provided on the mounting platform.

9. The buffer assembly according to claim 7, wherein the mounting position is provided with a mounting interface;
wherein the mounting interface is configured to connect to the filming device; and
wherein the mounting interface comprises at least one of a 1/4 inch screw, a 3/8 inch screw, a cold shoe mount, a cold shoe slot, a NATO rail, a NATO slot, a Manfrotto rail, a Manfrotto slot, an Arca-Swiss compatible rail, or an Arca-Swiss compatible slot.

10. The buffer assembly according to any one of claim 1, wherein the second base comprises a mounting groove;
wherein the mounting position is provided within the mounting groove;
wherein the buffer assembly further comprises a locking assembly; and
wherein the locking assembly is movably disposed on a groove wall of the mounting groove for pressing against the filming device.

11. A vehicle-mounted filming device, comprising a suction cup, a shock absorption bracket, a connecting arm, and the buffer assembly according to claim 1, wherein a first end of the connecting arm is connected to the suction cup, a second end of the connecting arm is connected to a first end of the shock absorption bracket, and a second end of the shock absorption bracket is connected to the first base.
